(19) United States
(12) Patent Application Publication
(10) Pub. No.: US 2026/0067106 A1
(43) Pub. Date: Mar. 5, 2026

(54) TAMPER DETECTION SYSTEM

(71) Applicant: IHI Corporation, Tokyo (JP)

(72) Inventor: Eiichiro SORA, Tokyo (JP)

(21) Appl. No.: 19/380,975

(22) Filed: Nov. 6, 2025

Related U.S. Application Data
(63) Continuation of application No. PCT/JP2024/003117, filed on Jan. 31, 2024.

(30) Foreign Application Priority Data
May 17, 2023 (JP) 2023-081450

(51) Int. Cl. H04L 9/00

(52) U.S. Cl. CPC H04L 9/50

(57) ABSTRACT

A tamper detection system measures a physical parameter of a target node and outputs the physical parameter measured as a first measured value, receive the first measured value from a first route of the communication network, receive a calculated value from a second route of the communication network, in which the calculated value is obtained from at least one calculation performed on a second measured value of the physical parameter of the target node, and determines whether tampering has occurred along the second route based on the calculated value and the first measured value.

### CROSS-REFERENCE TO RELATED APPLICATIONS

This application is a continuation application of PCT Application No. PCT/JP2024/003117, filed on Jan. 31, 2024, which claims the benefit of priority from Japanese Patent Application No. 2023-081450, filed on May 17, 2023. The entire contents of which are incorporated herein by reference.

### BACKGROUND

Some techniques are used to improve the reliability of recording of measured values and the like.

Japanese Unexamined Patent Publication No. 2021-510223 discloses a technique for recording data related to carbon emissions and the like using a blockchain platform.

Data, such as a measured value, may pass through each of nodes, which are a plurality of devices and the like, and then may be used. The value passing through each node is likely to be tampered with.

In some techniques, for example, evidence of a value output from each node is acquired in order to assure the quality (or reliability) of a final value. Acquiring the evidence at each node may be costly and time consuming.

### SUMMARY

According to an example of the present disclosure, there is provided a tamper detection system (or quality assurance system) including: a measurement node to be measured; a measurement device outputting a first measured value obtained as a result of measuring a physical quantity related to the measurement node; a node group that relays a second measured value obtained as a result of measuring the physical quantity related to the measurement node and outputs a final value obtained as a result of performing at least one calculation on the second measured value; and a blockchain system that records the first measured value, the final value, and information of a function related to the calculation in the node group on a blockchain and determines whether tampering is present or absent in the node group, using the first measured value, the final value, and the information of the function.

### BRIEF DESCRIPTION OF DRAWINGS

FIG. 1 is a schematic diagram of a tamper detection system.

FIG. 2 is a schematic diagram showing an example process of relaying a value.

FIG. 3 is a schematic diagram showing an example of a process of determining whether tampering has occurred based on a composite function.

FIG. 4 is a schematic diagram showing an example of a process of determining whether tampering has occurred based on an inverse function of the composite function.

FIG. 5 is a sequence diagram showing an example of an operation of the tamper detection system.

FIG. 6 is a schematic diagram showing an example of a hardware configuration of a device of the tamper detection system.

### DETAILED DESCRIPTION

According to an example of the present disclosure, there is provided a quality assurance system including: a measurement node to be measured; a measurement device outputting a first measured value obtained as a result of measuring a physical quantity related to the measurement node; a node group that relays a second measured value obtained as a result of measuring the physical quantity related to the measurement node and outputs a final value obtained as a result of performing at least one calculation on the second measured value; and a blockchain system that records the first measured value, the final value, and information of a function related to the calculation in the node group on a blockchain and determines whether tampering is present or absent in the node group, using the first measured value, the final value, and the information of the function.

According to another example of the present disclosure, there is provided a quality assurance method executed by a quality assurance system including a measurement node to be measured, a measurement device, a node group, and a blockchain system. The quality assurance method includes: an operation of causing the measurement device to output a first measured value obtained as a result of measuring a physical quantity related to the measurement node; an operation of causing the node group to relay a second measured value obtained as a result of measuring the physical quantity related to the measurement node and to output a final value obtained as a result of performing at least one calculation on the second measured value; and an operation of causing the blockchain system to record the first measured value, the final value, and information of a function related to the calculation in the node group on a blockchain and to determine whether tampering is present or absent in the node group, using the first measured value, the final value, and the information of the function.

In the quality assurance system or the quality assurance method, the first measured value and the second measured value are measured for the physical quantity of the measurement node. The first measured value, the final value, and the information of the function are recorded on the blockchain. Therefore, it may be possible to ensure the reliability of the first measured value, the final value, and the information of the function. Then, it is determined whether tampering is present or absent in the node group, using the first measured value, the final value, and the information of the function. Therefore, it may be possible to assure the quality of the second measured value passing through the node group.

The information of the function may be a composite function obtained by combining a plurality of functions used in the node group. The blockchain system may calculate an estimated value of the final value, using the first measured value and the composite function, and compare the final value with the estimated value of the final value to determine whether the tampering is present or absent. In such examples, the first measured value is substituted into the composite function to calculate the estimated value of the final value after passing through the node group. Whether tampering is present or absent in the node group is determined by the comparison between the final value and the estimated value of the final value. Therefore, it may be possible to suppress an increase in calculation cost while ensuring the quality assurance of the value.

The information of the function may be an inverse function of a composite function obtained by combining a plurality of functions used in the node group. The blockchain system may calculate an estimated value of a second measured value, using the final value and the inverse function, and compare the first measured value with the estimated value of the second measured value to determine whether the tampering is present or absent. In such examples, the final value is substituted into the inverse function of the composite function to calculate the estimated value of the second measured value before passing through the node group. Whether tampering is present or absent in the node group is determined by the comparison between the estimated value of the first measured value and the estimated value of the second measured value. Therefore, it may be possible to suppress an increase in calculation cost while ensuring the quality assurance of the value.

The blockchain system may determine whether the tampering is present or absent, further using a predetermined threshold value determined based on an error of the node group. An error may occur in the final value when the final value passes through the node group. In contrast, since the first measured value does not pass through the node group, the error of the first measured value tends to be smaller than that of the final value and may be considered to be negligible. Since the predetermined threshold value is used to determine whether tampering is present or absent, the accuracy of determining whether tampering is present or absent is improved.

The first measured value and the second measured value may be values for evaluating an environmental value. The values for evaluating the environmental value and may be relayed and utilized at various nodes. According to the quality assurance system of the present disclosure, it may be possible to assure the quality (reliability) of the values for evaluating the environmental value with a simple method.

The measurement device may output the first measured value through a first route. The node group may relay the second measured value through a second route different from the first route. In such examples, the first measured value and the second measured value are relayed through the first route and the second route, respectively, and then linked. Therefore, the independence of the first measured value and the second measured value is ensured. As a result, it may be possible to improve the reliability of the determination of whether tampering is present or absent.

Hereinafter, examples of the present disclosure will be described in detail with reference to the accompanying drawings. In the description of the drawings, the same elements are denoted by the same reference numerals, and a redundant description thereof will be omitted.

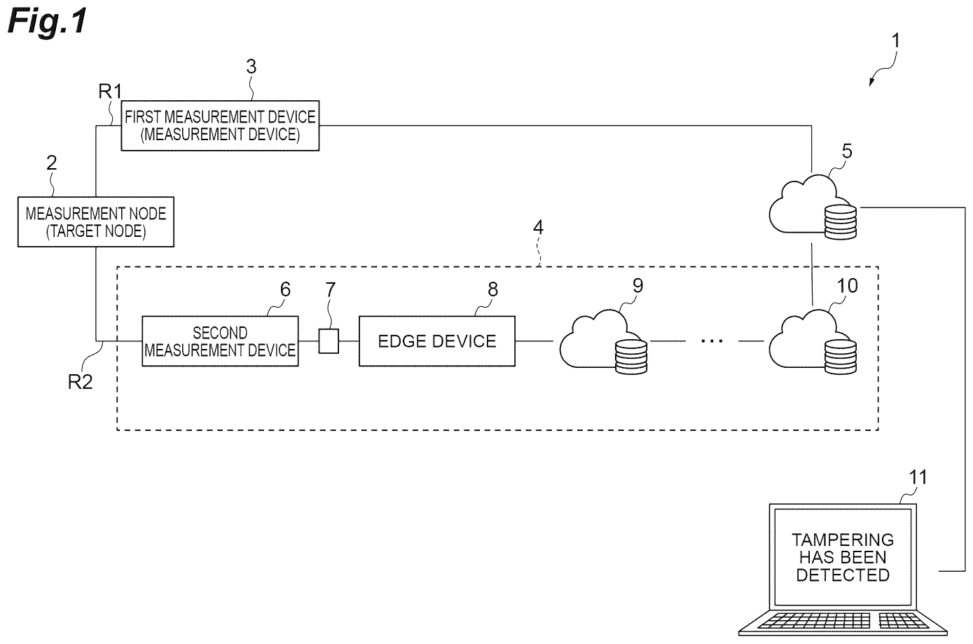

FIG. 1 is a schematic diagram showing an example of application of a tamper detection system 1, also referred to herein as a quality assurance system 1. The quality assurance system 1 according to the present disclosure assures or determines a quality of a measured value of a measurement target. The value whose quality is assured is, for example, a value for evaluating an environmental value or a value used by an Internet-of-Things (IoT) platform, but is not limited thereto. The measured value is, for example, a current, a voltage, power, a vibration, a rotation speed, or a temperature, but is not limited thereto. The value for evaluating the environmental value is, for example, emissions of CO₂, methane, greenhouse gas, or the like, but is not limited thereto. Hereinafter, an example will be described in which the quality assurance system 1 is applied to a situation in which the quality of a measured value of a current is assured.

The quality assurance system 1 includes a measurement node (or target node) 2, a first measurement device 3 (measurement device), a node group 4 (calculation device), and a blockchain system 5 (determination device). The quality assurance system 1 forms a communication network (e.g., computer network) that includes a first route R1 and a second route R2, each having the measurement node 2 as a starting point and the blockchain system 5 as an end point to communicate data. The first route R1 and the second route R2 are different from each other. The first measurement device 3 is disposed on the first route R1. The node group 4 is disposed on the second route R2. Some or all of the measurement node 2, the first measurement device 3, and the node group 4 may be managed by different organizations.

The measurement node (or target node) 2 is a device to be measured. The measurement node 2 outputs a physical quantity which is a quantity of a physical parameter (or a physical property in some examples) of the measurement node (or target node) 2. In some examples, the measurement node 2 is a solar panel. In such examples, the measurement node 2 outputs a current or the like. Locking management may be performed on the measurement node 2.

The first measurement device 3 is a device measuring the physical quantity related to the measurement node 2. The first measurement device 3 has, for example, a sensor function of measuring a physical quantity, a conversion function of converting a measured value into digital data, and an output function of outputting the measured value converted into the digital data. The first measurement device 3 outputs a first measured value obtained as a result of measuring the physical quantity related to the measurement node 2. For example, the first measurement device 3 converts a current value, which is analog data obtained by measuring the measurement node 2, into digital data and outputs the digital data as the first measured value. The first measurement device 3 transmits the first measured value to the blockchain system 5. The first measurement device 3 outputs the first measured value through the first route. The first measurement device 3 may have a tamper-proof function. The tamper-proof function may be implemented by meters based on industry standards or approvals.

The node group 4 relays a second measured value obtained as a result of measuring the physical quantity related to the measurement node 2 and outputs a final value (or calculated value) obtained as a result of performing at least one calculation on the second measured value. There is no limitation on the configuration of the node group 4. The node group 4 includes, for example, a second measurement device 6, a conversion module 7, an edge device 8, and clouds 9 and 10. The node group 4 relays the second measured value through the second route R2. The node group 4 may include a node that does not perform any calculation on the second measured value that is being relayed. The node that does not perform any calculation may be regarded as a node performing a calculation using a function that does not change the value. The order of relay may be determined in advance in the node group 4. The node group 4 transmits information of a function related to the calculations in the node group 4 to the blockchain system 5. The calculations are, for example, calculating power [KW] from a current [A], calculating the amount of power “kWh” from the power [KW], and calculating CO₂ emissions using the amount of power [kWh] and a specified coefficient, but are not limited thereto.

The second measurement device 6 is a device measuring the physical quantity of the measurement node 2. For example, the second measurement device 6 is a current sensor. The second measurement device 6 outputs, as the second measured value, a current value which is analog data obtained by measuring the measurement node 2. The second measured value may be a value measured under the same conditions as the first measured value.

The conversion module 7 is a device converting the second measured value, which is the analog data, into digital data. The conversion module 7 relays between the second measurement device 6 and the edge device 8. The conversion module 7 functions as an interface converting a protocol between the second measurement device 6 and the edge device 8. The conversion module 7 may be integrated into the second measurement device 6.

The edge device 8 is a device relaying the second measured value to the cloud 9. The edge device 8 may process the second measured value into a predetermined format. The type of the edge device is not limited. For example, the edge device may be a personal computer. The edge device 8 may be a high-functionality mobile phone (smartphone), a tablet terminal, a wearable terminal, or the like.

Each of the clouds 9 and 10 is a combination of any computers available via the communication network. For example, the clouds 9 and 10 are computer systems used by each of a plurality of organizations. A plurality of nodes (for example, clouds) may be present between the clouds 9 and 10. The organization using the cloud 9 may be different from the organization using the cloud 10.

The blockchain system 5 is a computer system configured by a plurality of nodes. For example, the blockchain system 5 shares a ledger on a blockchain. The blockchain system 5 publishes transaction information as deal information. The blockchain system 5 verifies the validity of the transaction information. The nodes in the blockchain system 5 are different from each node in the node group 4.

The blockchain system 5 records the first measured value, the final value, and the information of the function related to the calculation in the node group 4 on the blockchain. The blockchain system 5 may record the information of the function in advance. The blockchain system 5 determines whether tampering is present or absent in the node group 4, using the first measured value, the final value, and the information of the function. The blockchain system 5 may record tampering presence or absence information, which is a determination result, on the blockchain or may output the tampering presence or absence information to an external system. The tampering presence or absence information may be represented by, for example, 1 or 0.

A terminal 11 is a node constituting the block chain system 5. The terminal 11 displays, on a display device, the tampering presence or absence information recorded on the blockchain system 5. The terminal 11 may select a message based on the tampering presence or absence information and display the message. For example, a message saying “Tampering has been detected” may be displayed on the display device of the terminal 11. The terminal 11 may be a computer device of an external system.

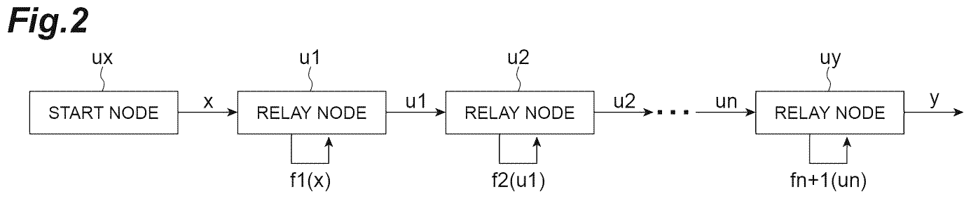

FIG. 2 is a view showing an example of the relay of a value. FIG. 2 shows an example in which a value “x” is relayed by a plurality of nodes and a value “y” is finally output. In FIG. 2, a start node ux and relay nodes u1, u2, and uy are disposed in this order. One or more relay nodes may be present between the relay node u2 and the relay node uy. The start node ux corresponds to, for example, the measurement node 2. The relay nodes u1, u2, and uy correspond to, for example, the node group 4. A function corresponds to each of the relay nodes u1, u2, and uy.

The start node ux outputs “x” which is a physical quantity. The relay node u1 acquires “x” as an input value from the start node ux. For example, the relay node u1 acquires the measured value “x” of the start node ux as the input value. The relay node u1 outputs “u1”, which is a calculation result, using a function “f1(x)”. The relay node u2 acquires “u1” as an input value from the relay node u1. The relay node u2 outputs “u2”, which is a calculation result, using a function “f2(u1)”. In this way, the value is relayed, and the calculation is executed. The value that is being relayed may also be called a relay value. The relay node uy acquires, as an input value, “un” which is a calculation result of the previous relay node in the order. The relay node uy outputs “y”, which a calculation result, using a function fn+1(un). y is a final value that is finally output.

Here, “y”, which is the calculation result, may be represented by a composite function which is a function obtained by combining a plurality of functions. The composite function is a function obtained by combining the functions in the order of the relay nodes u1, u2, and uy. For example, the composite function may be represented by the following expression.

$$\begin{matrix}y = fn + 1 ( u n ) \\ = fn + 1 ( fn ( … f 2 ( f 1 ( x ) ) ) … ) \\ = F ( x )\end{matrix} \qquad ( 1 )$$

In Expression (1), F(x) is as follows.

$$F ( x ) = f n + 1 ( fn ( … f 2 ( f 1 ( x ) ) ) … )$$

An inverse function of Expression (1) may be represented by the following expression.

$$x = {F}^{- 1} ( y ) \qquad ( 2 )$$

Expression (1), which is the composite function, may calculate an estimated value of the final value y. The blockchain system 5 may record Expression (1) as the information of the function. Expression (2), which is the inverse function of the composite function, may calculate an estimated value of the second measured value before being relayed. The blockchain system 5 may record Expression (2) as the information of the function.

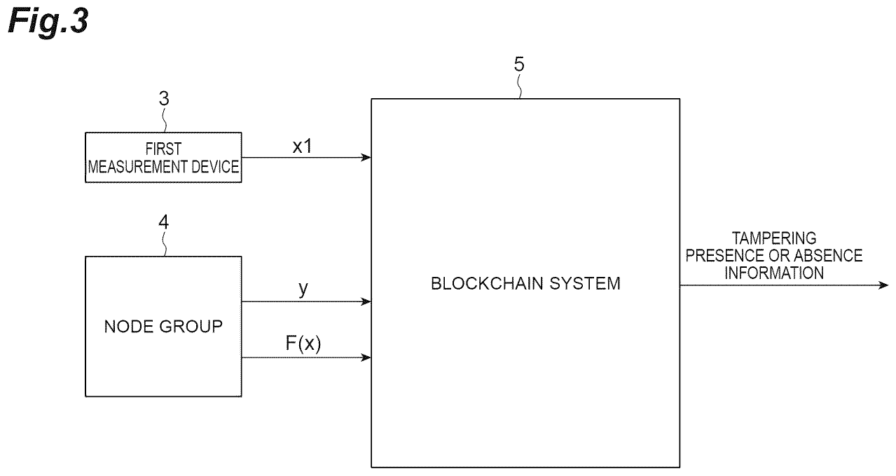

FIG. 3 is a schematic view showing an example of a process of determining whether tampering is present or absent, using the composite function. The blockchain system 5 acquires a first measured value x1 from the first measurement device 3. The first measured value x1 is a measured value of the measurement node 2 by the first measurement device 3. The blockchain system 5 acquires the final value y and the composite function F(x) as the information of the function from the node group 4. The composite function F(x) is a function represented by Expression (1). The blockchain system 5 records the first measured value x1, the final value y, and the composite function F(x) on the blockchain.

The blockchain system 5 calculates an estimated value y′ of the final value y, using the first measured value x1 and the composite function F(x). For example, the blockchain system 5 substitutes the first measured value x1 into the composite function F(x) to calculate the estimated value y′ of the final value y.

The blockchain system 5 compares the final value y with the estimated value y′ of the final value y to determine whether tampering is present or absent. For example, when there is no difference between the final value y and the estimated value y′ of the final value y, the blockchain system 5 may determine that tampering is absent. When there is a difference between the final value y and the estimated value y′ of the final value y, the blockchain system 5 may determine that tampering is present.

The blockchain system 5 may determine whether tampering is present or absent, further using a predetermined threshold value θ. A method of determining the predetermined threshold value θ is not limited. For example, the predetermined threshold value θ may be determined based on an error of the node group 4. When data passes through the node group 4, an error may occur due to a factor such as the performance or environment of each node. The predetermined threshold value θ may be determined so as to allow the error. The blockchain system 5 may determine whether tampering is present or absent, using the following expression.

$$\vert F ( x ) - y \vert < θ \qquad ( 3 )$$

The blockchain system 5 may determine that tampering is absent when the condition of Expression (3) is satisfied. The blockchain system 5 may determine that tampering is present when the condition of Expression (3) is not satisfied.

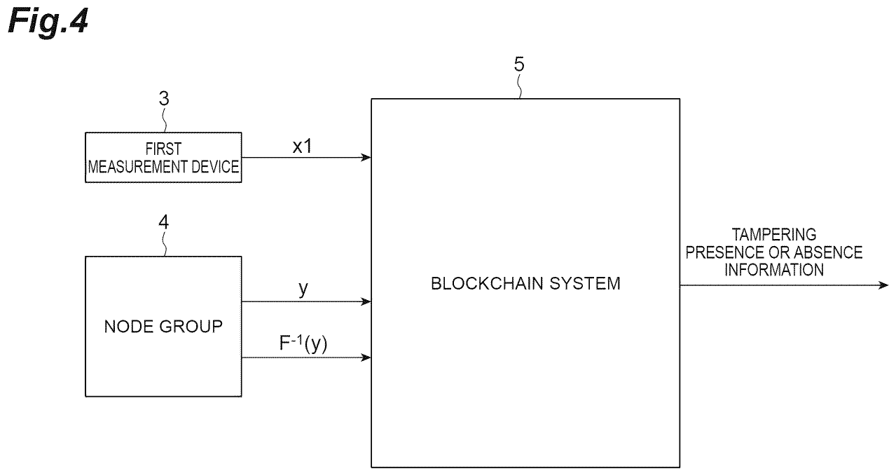

FIG. 4 is a schematic view showing an example of a process of determining whether tampering is present or absent using the inverse function of the composite function. The blockchain system 5 acquires the first measured value x1 from the first measurement device 3. The blockchain system 5 acquires the final value y and the inverse function F⁻¹(y) of the composite function as the information of the function from the node group 4. The inverse function F⁻¹(y) of the composite function is a function represented by Expression (2). The blockchain system 5 records the first measured value x1, the final value y, and the inverse function F⁻¹(y) of the composite function on the blockchain.

The blockchain system 5 calculates an estimated value x2′ of a second measured value x2 using the final value y and the inverse function F⁻¹(y) of the composite function. The second measured value x2 is the measured value of the measurement node 2 by the measurement device (for example, the second measurement device 6) of the node group 4. For example, the blockchain system 5 substitutes the final value y into the inverse function F⁻¹(y) of the composite function to calculate the estimated value x2′ of the second measured value x2.

The blockchain system 5 compares the first measured value x1 with the estimated value x2′ of the second measured value x2 to determine whether tampering is present or absent. For example, the blockchain system 5 may determine that tampering is absent when there is no difference between the first measured value x1 and the estimated value x2′ of the second measured value x2. For example, the blockchain system 5 may determine that tampering is present when there is a difference between the first measured value x1 and the estimated value x2′ of the second measured value x2.

The blockchain system 5 may determine whether tampering is present or absent, further using the predetermined threshold value θ. The blockchain system 5 may determine whether tampering is present or absent, using the following expression.

$$\vert {F}^{- 1} ( y ) - x 1 \vert < θ \qquad ( 4 )$$

The blockchain system 5 may determine that tampering is absent when the condition of Expression (4) is satisfied. The blockchain system 5 may determine that tampering is present when the condition of Expression (4) is not satisfied.

### [Operation of Quality Assurance System]

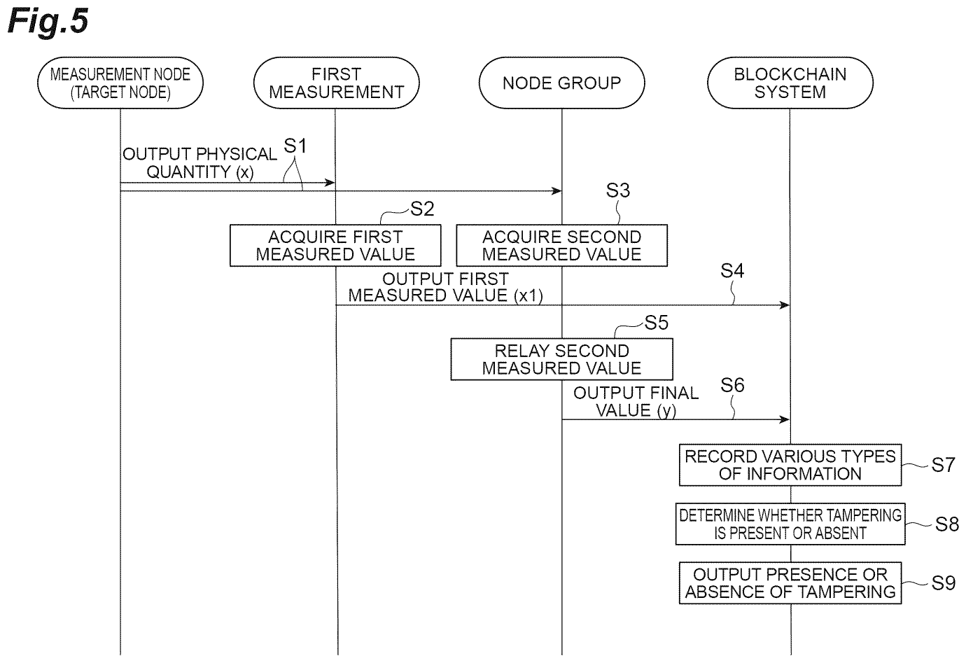

An example of an operation method (quality assurance method) by the quality assurance system 1 will be described with reference to FIG. 5. FIG. 5 is a sequence view showing an example of the operation of the quality assurance system 1. In FIG. 5, the description will be made assuming that the blockchain system 5 records in advance the information of the function related to the calculation in the node group 4.

In operation S1, the measurement node 2 outputs a physical quantity. For example, the measurement node 2 outputs “x” as the current value.

In operation S2, the first measurement device 3 acquires the first measured value. For example, the first measurement device 3 acquires the first measured value x1 obtained as the result of measuring the physical quantity related to the measurement node 2. The first measured value x1 corresponds to “x” which is the current value output by the measurement node 2.

In operation S3, the node group 4 acquires the second measured value. For example, the second measurement device 6 acquires the second measured value x2 obtained as the result of measuring the physical quantity related to the measurement node 2. The second measured value x2 corresponds to “x” which is the current value output by the measurement node 2.

In operation S4, the first measurement device 3 outputs the first measured value. For example, the first measurement device 3 outputs the first measured value x1 to the blockchain system 5. The first measurement device 3 outputs the first measured value x1 through the first route R1.

In operation S5, the node group 4 relays the second measured value x2. The node group 4 relays the second measured value x2 through the second route R2. The node group 4 relays the second measured value x2 and calculates the final value y obtained as the result of performing at least one calculation on the second measured value x2.

In operation S6, the node group 4 outputs the final value y. For example, the node group 4 outputs the final value y to the blockchain system 5.

In operation S7, the blockchain system 5 records various types of information on the blockchain. For example, the blockchain system 5 records the first measured value x1 and the final value y on the blockchain. Here, the information of the function related to the calculation in the node group 4 is recorded on the blockchain in advance.

In operation S8, the blockchain system 5 determines whether tampering is present or absent in the node group 4. The blockchain system 5 determines whether tampering is present or absent in the node group 4, using the first measured value, the final value, and the information of the function.

The blockchain system 5 may calculate the estimated value y′ of the final value y, using the first measured value x1 and the composite function F(x). The blockchain system 5 may compare the final value y with the estimated value y′ of the final value y to determine whether tampering is present or absent. The blockchain system 5 may determine whether tampering is present or absent, further using the predetermined threshold value θ. The blockchain system 5 may determine whether tampering is present or absent, using Expression (3).

The blockchain system 5 may calculate the estimated value x2′ of the second measured value x2 using the final value y and the inverse function F⁻¹(y) of the composite function. The blockchain system 5 may compare the first measured value x1 with the estimated value x2′ of the second measured value x2 to determine whether tampering is present or absent. The blockchain system 5 may determine whether tampering is present or absent, further using the predetermined threshold value θ. The blockchain system 5 may determine whether tampering is present or absent, using Expression (4).

In operation S9, the blockchain system 5 outputs the presence or absence of tampering. For example, the blockchain system 5 may record the tampering presence or absence information, which is the result of determining whether tampering is present or absent, on the blockchain or may output the tampering presence or absence information to an external system. For example, the terminal 11 constituting the blockchain system 5 may display, on the display device, the tampering presence or absence information recorded on the blockchain system 5.

The quality assurance method is not limited to the example in the above-described example. For example, some of the above-described operations (processes) may be omitted, or the operations may be executed in a different order. In addition, any two or more of the above-described operations may be combined, or some of the operations may be modified or deleted. Alternatively, other operations may be executed in addition to each of the above-described operations.

### [Hardware Configuration]

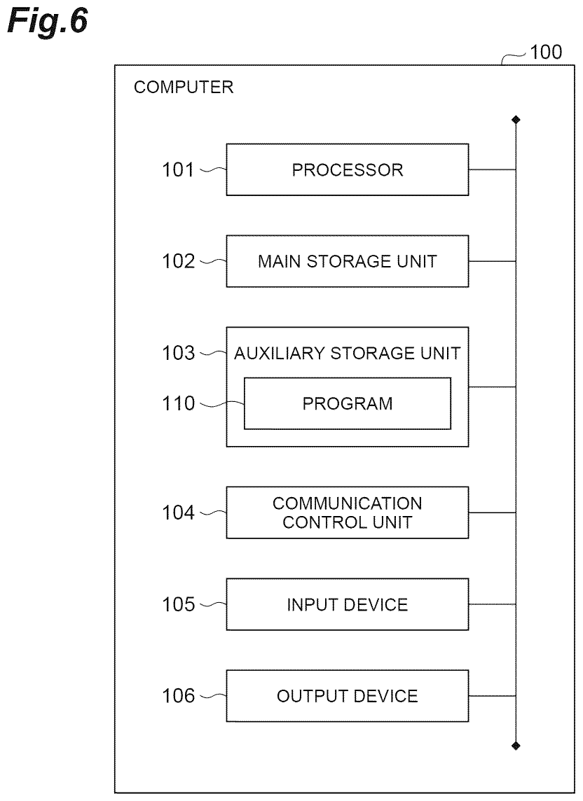

FIG. 6 shows an example of a hardware configuration related to the quality assurance system 1. FIG. 6 shows a computer 100 functioning as the terminal 11. The computer 100 includes a processor 101, a main storage unit 102, an auxiliary storage unit 103, a communication control unit 104, an input device 105, and an output device 106. The terminal 11 is configured by one or more computers 100 configured by these hardware components and software such as a program.

When the terminal 11 is configured by a plurality of computers 100, these computers 100 may be connected locally or via a communication network such as the Internet or an intranet. One terminal 11 is logically constructed by this connection.

The processor 101 is a central processing unit (CPU) executing an operating system, application programs, and the like. The main storage unit 102 is configured by a read-only memory (ROM) and a random access memory (RAM). The auxiliary storage unit 103 is a storage medium configured by a hard disk, a flash memory, and the like. The auxiliary storage unit 103 generally stores a larger amount of data than the main storage unit 102. The communication control unit 104 is configured by a network card or a wireless communication module. At least a portion of a communication function of the terminal 11 with other devices may be implemented by the communication control unit 104. The input device 105 is configured by a keyboard, a mouse, a touch panel, a microphone for voice input, and the like. The output device 106 is configured by a display, a printer, and the like.

The auxiliary storage unit 103 stores in advance a program 110 (quality assurance program) and data used for processes. The program 110 causes the computer 100 to execute each functional element of the terminal 11. For example, the processes related to the quality assurance method are executed in the computer 100 by the program 110. For example, the program 110 is loaded by the processor 101 or the main storage unit 102 and operates at least one of the processor 101, the main storage unit 102, the auxiliary storage unit 103, the communication control unit 104, the input device 105, and the output device 106. For example, the program 110 reads and writes data from and to the main storage unit 102 and the auxiliary storage unit 103.

The program 110 may be recorded on a tangible storage medium, such as a CD-ROM, a DVD-ROM, or a semiconductor memory, and then provided. The program 110 may be provided as a data signal via the communication network.

The computer devices constituting the edge device 8 and the clouds 9 and 10 and each node constituting the blockchain system 5 may also have the same hardware configuration as the terminal 11.

As described above, according to an example of the present disclosure, there is provided the quality assurance system 1 including the measurement node 2 to be measured, a measurement device (first measurement device 3) outputting a first measured value obtained as a result of measuring a physical quantity related to the measurement node 2, the node group 4 that relays a second measured value obtained as a result of measuring the physical quantity related to the measurement node 2 and outputs a final value obtained as a result of performing at least one calculation on the second measured value, and the blockchain system 5 that records the first measured value, the final value, and information of a function related to the calculation in the node group on a blockchain and determines whether tampering is present or absent in the node group 4, using the first measured value, the final value, and the information of the function.

According to another example of the present disclosure, there is provided a quality assurance method executed by the quality assurance system 1 including the measurement node 2 to be measured, a measurement device (first measurement device 3), the node group 4, and the blockchain system 5. The quality assurance method includes an operation of causing the measurement device to output a first measured value obtained as a result of measuring a physical quantity related to the measurement node 2, an operation of causing the node group 4 to relay a second measured value obtained as a result of measuring the physical quantity related to the measurement node 2 and to output a final value obtained as a result of performing at least one calculation on the second measured value, and an operation of causing the blockchain system 5 to record the first measured value, the final value, and information of a function related to the calculation in the node group 4 on a blockchain and to determine whether tampering is present or absent in the node group 4, using the first measured value, the final value, and the information of the function.

In the quality assurance system 1 or the quality assurance method, the first measured value and the second measured value are measured for the physical quantity of the measurement node 2. The first measured value, the final value, and the information of the function are recorded on the blockchain. Therefore, it may be possible to ensure the reliability of the first measured value, the final value, and the information of the function. Then, it is determined whether tampering is present or absent in the node group 4, using the first measured value, the final value, and the information of the function. Therefore, it may be possible to assure the quality of the second measured value passing through the node group 4.

In the method according to the related art, for example, when a value is relayed between a plurality of nodes, work, such as obtaining evidence of the value relayed between the plurality of nodes, may occur. As the number of relay nodes increases, the number of points where tampering is likely to occur increases. Therefore, as the number of relay nodes increases, the cost and time to obtain the evidence also increases. In contrast, according to the quality assurance system 1 of the present disclosure, since it is unnecessary to perform, for example, the acquisition of evidence in the node group 4, it may be possible to suppress increases in cost and time. Further, even when a new node is added to the node group 4, it is sufficient to add information of the corresponding function. For example, when the relay order in the node group 4 is changed by the addition of a new node, it is sufficient for the blockchain system 5 to record the information of the function corresponding to the changed order. Therefore, the quality assurance system 1 according to the present disclosure may be improved in expandability.

The information of the function is a composite function obtained by combining a plurality of functions used in the node group 4. The blockchain system 5 calculates an estimated value of the final value, using the first measured value and the composite function, and compares the final value with the estimated value of the final value to determine whether the tampering is present or absent. In this example, the first measured value is substituted into the composite function to calculate the estimated value of the final value after passing through the node group 4. Whether tampering is present or absent in the node group 4 is determined by the comparison between the final value and the estimated value of the final value. Therefore, it may be possible to suppress an increase in calculation cost while ensuring the quality assurance of the value.

The information of the function is an inverse function of a composite function obtained by combining a plurality of functions used in the node group 4. The blockchain system 5 calculates an estimated value of the second measured value, using the final value and the inverse function, and compares the first measured value with the estimated value of the second measured value to determine whether the tampering is present or absent. In this example, the final value is substituted into the inverse function of the composite function to calculate the estimated value of the second measured value before passing through the node group 4. Whether tampering is present or absent in the node group 4 is determined by the comparison between the estimated value of the first measured value and the estimated value of the second measured value. Therefore, it may be possible to suppress an increase in calculation cost while ensuring the quality assurance of the value.

The blockchain system 5 determines whether the tampering is present or absent, further using a predetermined threshold value determined based on an error of the node group 4. An error may occur in the final value when the final value passes through the node group 4. In contrast, since the first measured value does not pass through the node group 4, the error of the first measured value tends to be smaller than that of the final value and may be considered to be negligible. Since the predetermined threshold value is used to determine whether tampering is present or absent, the accuracy of determining whether tampering is present or absent is improved.

The first measured value and the second measured value are values for evaluating an environmental value. The values for evaluating the environmental value may be relayed and utilized at various nodes. According to the quality assurance system 1 of the present disclosure, it may be possible to assure the quality (reliability) of the values for evaluating the environmental value with a simple method.

The measurement device outputs the first measured value through a first route. The node group 4 relays the second measured value through a second route different from the first route. In this example, the first measured value and the second measured value are relayed through the first route and the second route, respectively, and then linked. Therefore, the independence of the first measured value and the second measured value is ensured. As a result, it may be possible to improve the reliability of the determination of whether tampering is present or absent.

### MODIFICATION EXAMPLES

It is to be understood that not all aspects, advantages and features described herein may necessarily be achieved by, or included in, any one particular example. Indeed, having described and illustrated various examples herein, it should be apparent that other examples may be modified in arrangement and detail.

In the above-described example, the example has been described in which the first measured value and the second measured value are current values. However, the present disclosure is not limited thereto. The first measured value and the second measured value may be voltage values, power values, vibration values, rotation speeds, and temperatures, and the like. The first measured value and the second measured value may be different from each other. In some examples, the first measured value may be a current value, and the second measured value may be a vibration value. In such examples, the blockchain system 5 may determine whether tampering is present or absent using the composite function shown in Expression (1).

In the above-described example, it has been described that, since the first measured value does not pass through node group 4, the error of the first measured value tends to be smaller than that of the final value and may be considered to be negligible. However, the error may also be taken into consideration. When the measurement device (first measurement device 3) is calibrated, the error of the first measured value is quantitatively determined. Therefore, the error of the first measured value may be used to determine the predetermined threshold value θ shown in Expression (3) or Expression (4).

In the above-described example, the example has been described in which it is determined whether tampering is present or absent, further using the predetermined threshold value determined based on the error of the node group 4. However, the present disclosure is not limited thereto. The predetermined threshold value may be a threshold value determined by a given industry.

In the comparison between the magnitudes of two numerical values, either of two criteria “equal to or greater than” and “exceed (greater than)” may be used, or either of two criteria “equal to or less than” and “less than” may be used.

The present disclosure includes the following configurations.

A configuration [1] may be described as: a quality assurance system including: a measurement node to be measured; a measurement device outputting a first measured value obtained as a result of measuring a physical quantity related to the measurement node; a node group that relays a second measured value obtained as a result of measuring the physical quantity related to the measurement node and outputs a final value obtained as a result of performing at least one calculation on the second measured value; and a blockchain system that records the first measured value, the final value, and information of a function related to the calculation in the node group on a blockchain and determines whether tampering is present or absent in the node group, using the first measured value, the final value, and the information of the function.

A configuration [2] may be described as: the quality assurance system according to the configuration [1], wherein the information of the function is a composite function obtained by combining a plurality of functions used in the node group, and the blockchain system calculates an estimated value of the final value, using the first measured value and the composite function, and compares the final value with the estimated value of the final value to determine whether the tampering is present or absent.

A configuration [3] may be described as: the quality assurance system according to the configuration [1] or [2], wherein the information of the function is an inverse function of a composite function obtained by combining a plurality of functions used in the node group, and the blockchain system calculates an estimated value of the second measured value, using the final value and the inverse function, and compares the first measured value with the estimated value of the second measured value to determine whether the tampering is present or absent.

A configuration [4] may be described as: the quality assurance system according to any one of the configurations [1] to [3], wherein the blockchain system determines whether the tampering is present or absent, further using a predetermined threshold value determined based on an error of the node group.

A configuration [5] may be described as: the quality assurance system according to any one of the configurations [1] to [4], wherein the first measured value and the second measured value are values for evaluating an environmental value.

A configuration [6] may be described as: the quality assurance system according to any one of the configurations [1] to [5], wherein the measurement device outputs the first measured value through a first route, and the node group relays the second measured value through a second route different from the first route.

A configuration [7] may be described as: a quality assurance method executed by a quality assurance system including a measurement node to be measured, a measurement device, a node group, and a blockchain system, the quality assurance method including: an operation of causing the measurement device to output a first measured value obtained as a result of measuring a physical quantity related to the measurement node; an operation of causing the node group to relay a second measured value obtained as a result of measuring the physical quantity related to the measurement node and to output a final value obtained as a result of performing at least one calculation on the second measured value; and an operation of causing the blockchain system to record the first measured value, the final value, and information of a function related to the calculation in the node group on a blockchain and to determine whether tampering is present or absent in the node group, using the first measured value, the final value, and the information of the function.

1. A tamper detection system comprising:
a target node to be measured;
a measurement device configured to output a first measured value obtained by measuring a physical quantity related to the target node;
a node group configured to acquire a second measured value obtained by measuring the physical quantity related to the target node, to relay the second measured value by performing at least one calculation on the second measured value, and to output a calculated value obtained from the at least one calculation; and
a blockchain system configured to record on a blockchain, the first measured value, the calculated value, and a function representing the at least one calculation in the node group, and to determine whether tampering has occurred in the node group, based on the first measured value, the calculated value, and the function.

2. The tamper detection system according to claim 1,
wherein the function is a composite function obtained by combining a plurality of functions used in the node group to perform the at least one calculation, and
wherein the blockchain system is configured to calculate an estimated value of the calculated value, based on the first measured value and the composite function, and to compare the calculated value with the estimated value to determine whether the tampering has occurred.

3. The tamper detection system according to claim 1,
wherein the function is an inverse function of a composite function obtained by combining a plurality of functions used in the node group to perform the at least one calculation, and
wherein the blockchain system is configured to calculate an estimated value of the second measured value, based on the calculated value and the inverse function, and to compare the first measured value with the estimated value of the second measured value to determine whether the tampering has occurred.

4. The tamper detection system according to claim 1, wherein the blockchain system determines whether the tampering has occurred, further based on a predetermined threshold value that is determined based on an error of the node group.

5. The tamper detection system according to claim 1, wherein the first measured value and the second measured value are values for evaluating an environmental value.

6. The tamper detection system according to claim 1,
wherein the measurement device is configured to output the first measured value through a first route of a communication network, and
wherein the node group is configured to relay the second measured value through a second route of the communication network, different from the first route.

7. A tamper detection method for a communication network, comprising:
outputting a first measured value obtained by measuring a physical quantity related to a target node;
acquiring a second measured value obtained by measuring the physical quantity related to the target node;
relaying the second measured value by performing at least one calculation on the second measured value, via a node group, to obtain a calculated value; and
determining whether tampering has occurred in the node group, based on the first measured value, the calculated value, and a function representing the at least one calculation performed by the node group.

8. The tamper detection method according to claim 7, further comprising
acquiring a composite function obtained by combining a plurality of functions associated with the at least one calculation; and
calculating an estimated value based on the composite function,
wherein whether the tampering has occurred is determined based on a comparison of the estimated value with a selected value that is selected from the calculated value and the second measured value.

9. The tamper detection method according to claim 8,
wherein the estimated value corresponds to an estimation of the calculated value, and is obtained by applying the composite function to the first measured value, and
wherein the selected value in the comparison, is the calculated value.

10. The tamper detection method according to claim 8,
wherein the estimated value corresponds to an estimation of the second measured value, and is obtained by applying an inverse function of the composite function to the calculated value, and
wherein the selected value in the comparison, is the second measured value.

11. The tamper detection method according to claim 8, wherein the comparison includes:
determining a difference of the estimated value with the selected value; and
comparing the difference with a threshold value, to determine whether the tampering has occurred, wherein the threshold value is set based on an error in the node group.

12. A tamper detection system comprising:
a measurement device configured to measure a physical parameter of a target node of a communication network, and to output the physical parameter measured as a first measured value; and
one or more processors configured to:
receive the first measured value from a first route of the communication network;
receive a calculated value from a second route of the communication network, wherein the calculated value is obtained from at least one calculation performed on a second measured value of the physical parameter of the target node; and
determine whether tampering has occurred along the second route based on the calculated value and the first measured value.

13. The tamper detection system according to claim 12, further comprising a group of nodes configured to relay the second measured value along the second route of the communication network by performing the at least one calculation, and to output the calculated value to the one or more processors.

14. The tamper detection system according to claim 13,
wherein the measurement device is a first measurement device of the tamper detection system, and
wherein the group of nodes further includes a second measurement device configured to measure the second measured value of the physical parameter of the target node.

15. The tamper detection system according to claim 12, wherein the one or more processors are further configured to output a result as to whether the tampering has occurred, to a display device.

16. The tamper detection system according to claim 12, wherein the one or more processors form a blockchain system configured to record on a blockchain, the first measured value, the calculated value, and a function representing the at least one calculation.

17. The tamper detection system according to claim 16,
wherein the function is a composite function obtained by combining a plurality of functions associated with the at least one calculation, and
wherein the blockchain system is configured to calculate an estimated value of the calculated value, by applying the composite function to the first measured value, and to compare the calculated value with the estimated value, to determine whether the tampering has occurred.

18. The tamper detection system according to claim 16,
wherein the function is an inverse function of a composite function obtained by combining a plurality of functions associated with the at least one calculation, and
wherein the blockchain system is configured to calculate an estimated value of the second measured value, by applying the inverse function to the calculated value, and to compare the first measured value with the estimated value of the second measured value, to determine whether the tampering has occurred.

19. The tamper detection system according to claim 12, wherein the physical parameter associated with the first measured value and the second measured value, is one of a current, a voltage, an electric power, a vibration, a rotation speed, or a temperature measured at the target node.

20. The tamper detection system according to claim 12,
wherein the first measured value and the second measured value are measurements for quantifying an environmental emission associated with an operation of the target node, and
wherein the environmental emission is one of a CO₂ emission, a methane emission or a greenhouse gas emission.
